(19) United States
(12) Patent Application Publication
(10) Pub. No.: US 2026/0300955 A1
(43) Pub. Date: Oct. 1, 2026

(54) METHODS AND SYSTEMS FOR TWO FACTOR AUTHENTICATION FOR IDENTITY VERIFICATION AND PERMISSIONED DATA SHARE

(71) Applicant: Capital One Services, LLC, McLean, VA (US)

(72) Inventors: Bob Uni Koshy, Henrico, VA (US); Narmeen Rahman, Brooklyn, NY (US); Edward Abdullah, Bluffton, SC (US); Kiran Kumar Vallabhaneni, Dublin, CA (US); Marianne Huang, Brooklyn, NY (US)

(73) Assignee: Capital One Services, LLC, McLean, VA (US)

(21) Appl. No.: 19/578,265

(22) Filed: Mar. 25, 2026

Related U.S. Application Data
(60) Provisional application No. 63/778,028, filed on Mar. 26, 2025.

(51) Int. Cl. G06Q 20/34; G06Q 20/32; G06Q 20/38

(52) U.S. Cl. CPC G06Q 20/352; G06Q 20/3255; G06Q 20/3821

(57) ABSTRACT

Methods and systems for two-factor authentication for identity verification and permissioned data share are disclosed. An exemplary method includes receiving identification data associated with a user to gain access to an online service system and sending a request to one or more issuer servers associated with contactless card issuers to determine if any of the issuers have a user account associated with the identification data. The exemplary method further includes sending a link to a device associated with the user, wherein the user interacting with the link causes the device to receive encrypted data from the contactless card. The exemplary method further includes receiving and forwarding the encrypted data to an authentication server to validate the encrypted data. The exemplary method further includes sending a personal data element associated with the user to the online service system.

### CROSS-REFERENCE TO RELATED APPLICATION

This application claims priority to U.S. Provisional Patent Application No. 63/778,028, filed Mar. 26, 2025, the contents of which are incorporated by reference herein in their entirety.

### FIELD OF THE DISCLOSURE

The subject matter of the present disclosure generally relates to identity verification and security. More particularly, the present disclosure relates to two-factor authentication for identity verification and permissioned data share.

### BACKGROUND

Two-factor authentication is a security measure that has gained wide-spread integration in many account-based systems where users log into an account they've created using their own password and some other form of authentication. In some cases, two factor authentication may be desired before an account has been established with an online system (e.g., at creation of the account) or if an account is not to be created, but the online application or system is still designed to verify the identity of the user.

Contactless cards have also gained prominence in the consumer markets for not only processing payment transactions, but also for helping to provide identity verification.

These and other deficiencies exist. There is a need for improved systems for two-factor authentication and identity verification that provides additional functionality over available systems.

### SUMMARY

In one aspect, a method is disclosed herein, the method including receiving, at a computing device, identification data associated with a user attempting to gain access to an online service system. The method further includes, in response to receiving the identification data, sending, by the computing device, a request to one or more issuer servers associated with contactless card issuers to determine if any of the contactless card issuers has a user account associated with the identification data, the request including the identification data. The method further includes receiving, by the computing device, a reply from at least one of the one or more issuer servers associated with the contactless card issuers indicating that the identification data is associated with a user account and a contactless card associated with the at least one contactless card issuer. In some embodiments, the method includes, in response to receiving the reply, sending, by the computing device, a universal link to a mobile device associated with the user, where the user interacting with the universal link causes the mobile device to receive encrypted data from the contactless card. The method further includes receiving, at the computing device, the encrypted data and forwarding the encrypted data to an authentication server to validate the encrypted data. In response to the computing device receiving a message from the authentication server that the encrypted data has been validated, the method further includes sending, by the computing device, a personal data element associated with the user to the online service system.

In another aspect, a non-transitory computer-readable storage medium having executable instructions stored thereon, which when executed by a processing circuit of a device, cause the processing circuit to perform various operations. The operations include the processing circuit being configured to provide a website with identification data of a user of the device to receive access to services of the website. The processing circuit is further to receive, from a server in communication with the website, a universal link, wherein the user interacting with the universal link causes a prompt to be displayed on the device for the user to tap a contactless card to the device. The processing circuit is further to receive, from the contactless card, encrypted data to validate an identity of the user and send the encrypted data to an authentication frontend server, wherein the authentication front end server is to forward the encrypted data to an issuer authentication server associated with a contactless card issuer of the contactless card, the issuer authentication server to validate the identity of the user based on the encrypted data. In response to the identity of the user being validated, obtain access to services of the website.

In another aspect, a server hosting a website or application is disclosed. In some embodiments, the server includes a memory storing executable instructions thereon. The server also includes a processing circuit to execute the executable instructions, which when executed cause the server to perform various operations. For example, in some embodiments, the server is configured to receive identification data of a user attempting to obtain access to services of the website or application. The server is further configured to send the identification data of the user to a computing device of a switching and authentication network, the computing device being in communication with one or more contactless card issuers to authenticate an identity of the user. In response to the identity of the user being authenticated, the server is further configured to receive a personal data element associated with the user and generate a user account on the website or application using the personal data element. The server is further configured to grant access to services of the website or application to the user via the generated user account.

Non-transitory computer program products (i.e., physically embodied computer program products) are also described that store instructions, which, when executed by one or more data processors (i.e., processing circuit) of one or more computing systems, cause at least one data processor to perform operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

FIG. 1 illustrates a network diagram of a system in accordance with one embodiment.

FIG. 2A is a flow diagram in accordance with one embodiment.

FIG. 2B illustrates further operations in the flow diagram of FIG. 2A in accordance with one embodiment.

FIG. 3 illustrates a method in accordance with one embodiment.

FIG. 4 illustrates a contactless card in accordance with one embodiment.

FIG. 5 illustrates a transaction card component in accordance with one embodiment.

FIG. 6 illustrates a flow diagram in accordance with one embodiment.

FIG. 7 illustrates an example of a system configured to operate in accordance with one embodiment.

FIG. 8 illustrates a flow diagram in accordance with one embodiment.

FIG. 9A illustrates a flow diagram in accordance with one embodiment.

FIG. 9B illustrates additional operations in the flow diagram of FIG. 9A in accordance with one embodiment.

FIG. 9C illustrates additional operations in the flow diagram of FIG. 9A and FIG. 9B in accordance with one embodiment.

FIG. 10 illustrates a message format in accordance with one embodiment.

FIG. 11 illustrates a method in accordance with one embodiment.

FIG. 12 illustrates a distributed network authentication system in accordance with one embodiment.

FIG. 13 is a flow diagram illustrating a method in accordance with one embodiment.

FIG. 14 illustrates a computer architecture in accordance with one embodiment.

### DETAILED DESCRIPTION

The following description of embodiments provides non-limiting representative examples referencing numerals to particularly describe features and teachings of different aspects of the invention. The embodiments described will be recognized as capable of implementation separately, or in combination, with other embodiments from the description of the embodiments and the features and teachings of any embodiment can be interchangeably combined with the features and teachings of any other embodiment. A person of ordinary skill in the art reviewing the description of embodiments will be able to learn and understand the different described aspects of the invention. The description of embodiments will facilitate understanding of the invention to such an extent that other implementations, not specifically covered but within the knowledge of a person of skill in the art having read the description of embodiments, will be understood to be consistent with an application of the invention.

Furthermore, the described features, advantages, and characteristics of the embodiments may be combined in any suitable manner. A person of ordinary skill in the art will recognize that the embodiments may be practiced without one or more of the specific features or advantages of an embodiment. In other instances, additional features and advantages may be recognized in certain embodiments that may not be present in all embodiments. A person of ordinary skill in the art will understand that the described features, advantages, and characteristics of any embodiment can be interchangeably combined with the features, advantages, and characteristics of any other embodiment.

Disclosed herein are methods and systems for two-factor authentication for identity verification and permissioned data share. In some embodiments, a user attempts to create an account or check out as a guest on a website or application that provides a product or service. The user enters their name and phone number into the website and that data is sent to a switching network that connects to various contactless card issuers. These contactless card issuers check to see if they have an account corresponding to the first and last name of the user and their phone number. Any issuer that does have an account, sends eligible contactless cards to the switching network which then sends a universal link (e.g., URL, quick response (QR) code or other link) to the mobile device of the user for the user to select.

The user selects the link and is prompted to tap one of a list of contactless cards associated with the issuers that confirmed the account. For example, if bank 1 and bank 2 indicate to the switching network that they have accounts and contactless cards associate with the user data, the list presented to the user includes the contactless card for bank 1 and the contactless card for bank 2. The user selects which contactless card they will tap to their device and then they tap the correct card to the user device. Encrypted data is sent from the contactless card to the switching system, which then forwards the encrypted data to the appropriate issuer for the issuer to validate the encrypted data. If the encrypted data is validated, the personal data for the user is sent to the website the user is attempting to access or check out from. The personal data includes first and last name, birthdate, address, primary account number, email address, and other relevant personal information of the user and then that personal data can be used by the website to create an account for the user, or to check out without creating the account.

Some benefits to the presently disclosed system include increased security provided by multifactor authentication, an improved user experience for card tap interactions, and saving verified cards for future use.

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identity, perform a payment, launch applications, log into applications, autofill a form or field, navigate to a specified web location or app on a device, unlock a door, initiate a contactless card, verify themselves, and so forth.

The systems discussed herein may enable users to perform these functions in a multi-issuer environment. Further, the systems discussed herein enable card issuers or payment providers, such as banks, to issue contactless cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

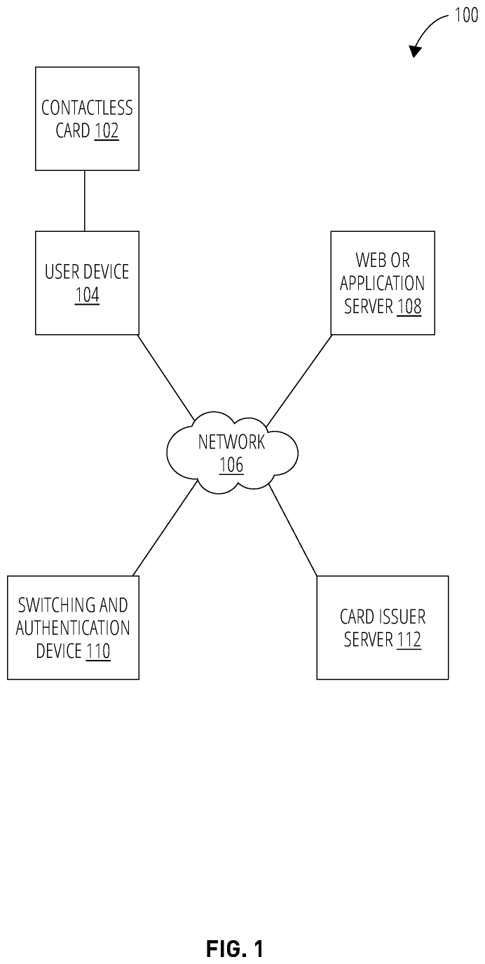

FIG. 1 illustrates a system 100, according to an example embodiment, for providing two factor authentication for identity verification and permissioned data share. As further discussed below, system 100 may include contactless card 102, user device 104, network 106, web or application server 108, switching and authentication device 110, and card issuer server 112. Although FIG. 1 illustrates single instances of the components, system 100 may include any number of components.

System 100 may include one or more contactless cards 102, which are further explained below. In some embodiments, contactless card 102 may be in wireless communication, utilizing NFC in an example, with user device 104.

System 100 may include user device 104, which may be a network-enabled computer. As referred to herein, a network-enabled computer may include, but is not limited to a computer device, or communications device including, e.g., a server, a network appliance, a personal computer, a workstation, a phone, a smartphone, a handheld PC, a personal digital assistant, a thin client, a fat client, an Internet browser, or other device. User device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 104 can include a processing circuit and a memory, and it is understood that the processing circuitry may contain additional components, including processors, memories, error and parity/CRC checkers, data encoders, anticollision algorithms, controllers, command decoders, security primitives and tamper proofing hardware, as necessary to perform the functions described herein. The user device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, user device 104 of system 100 may execute one or more applications or other executable instructions, such as software applications, that enable, for example, network communications with one or more components of system 100 and transmit and/or receive and process data as described herein.

System 100 may include one or more networks 106. In some examples, network 106 may be one or more of a wireless network, a wired network or any combination of wireless network and wired network, and may be configured to connect user device 104 to the web or application server 108, switching and authentication device 110, and/or the card issuer server 112. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. Network 106 may also support an Internet network, a wireless communication network, a cellular network, or the like, or any combination thereof. Network 106 may further include one network, or any number of the exemplary types of networks mentioned above, operating as a stand-alone network or in cooperation with each other. Network 106 may utilize one or more protocols of one or more network elements to which they are communicatively coupled. Network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 100 may also include a web or application server 108. The web or application server 108 may host a website or application for which a user of the user device 104 attempts to interact with, create an account for, or access services thereof. For example, the web or application server 108 may host a hotel website or rental website and the user device 104 may attempt to access the website and either an account is needed to actually book a hotel or check out a rental product. The system 100 and method 300 provided herein provides example embodiments of securely establishing an account or accessing the hotel booking or rental product without having to create an account.

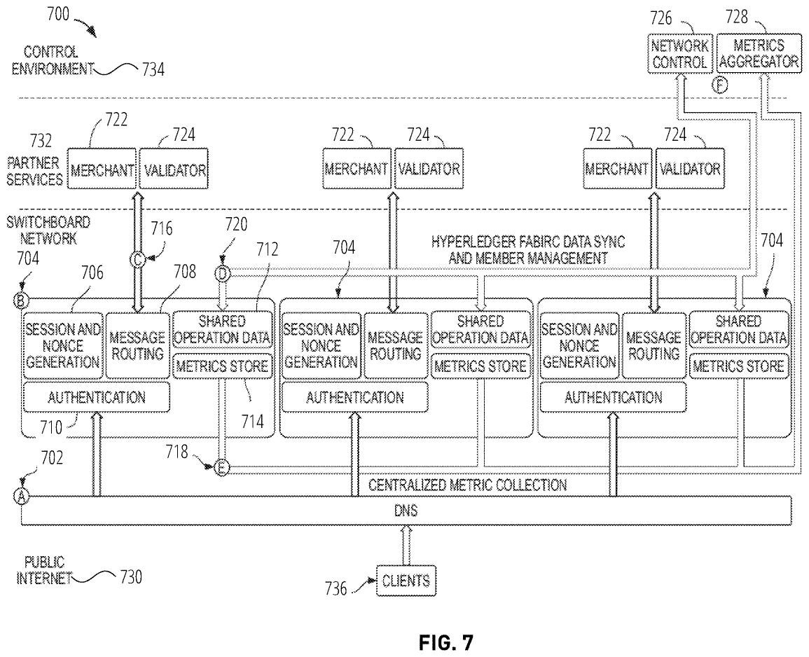

As discussed in more detail below, the system 100 further includes a switching and authentication device 110. The switching and authentication device 110 can include one or more of the devices in the system 700 described in FIG. 7. For example, the switching and authentication device 110 can include a switching network like the system 700. The switching network can be used to route data and requests from the user device 104 or the web or application server 108 to one or more other systems. For example, the switching and authentication device 110 can be used to route data from the user device 104 and/or the web or application server 108 to the card issuer server 112. The switching and authentication device 110 can also be used to authenticate encrypted data sent from the contactless card 102. As described in further detail below, the switching and authentication device 110 can include an authentication frontend server 204 and a switching and authentication device 110. Similarly, the switching and authentication device 110 can be used to route or switch data and responses from the card issuer server 112 to the user device 104 and the web or application server 108.

As described in further detail below, the card issuer server 112 can include one or more card issuer servers 112. These card issuer servers 112 can include a server associated with a credit card or contactless card issuer. For example, the card issuer servers 112 can be associated with corresponding banks, credit card companies, or any other organization that may issue contactless cards as described herein.

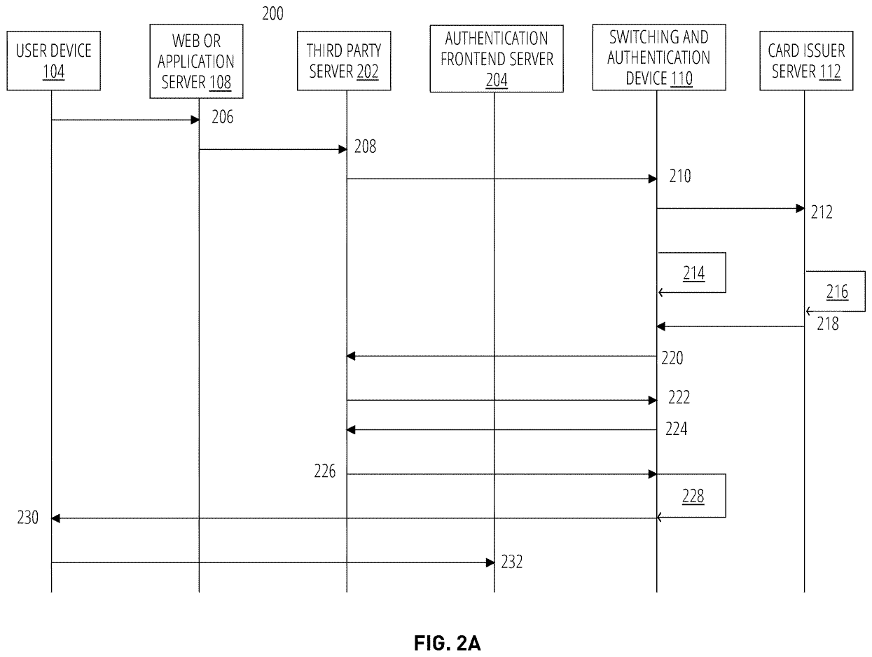

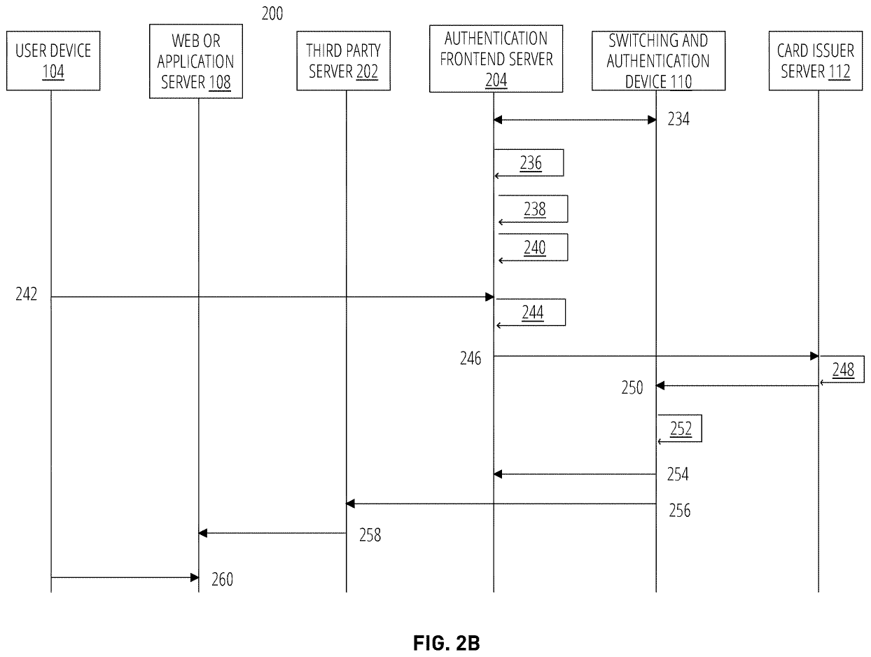

FIG. 2A is a flow diagram 200 that illustrates an example sequence of operations that are performed when a user, using the user device 104, attempts to access services or products of the web or application server 108. This flow diagram 200 includes communications between the user device 104, web or application server 108, switching and authentication device 110, and card issuer server 112, which can be performed over the network 106 from FIG. 1. However, the flow diagram 200 further includes communications between the above devices and a third party server 202 and an authentication frontend server 204. This third party server 202 can include a handoff device that helps to handle connections between the web or application server 108 and the authentication frontend server 204 and switching and authentication device 110. Similarly, the switching and authentication device 110 handles exchanges between the card issuer server 112 and other devices communicating therewith. The authentication frontend server 204 is a part of the switching and authentication device 110 and provides a user-facing functionality for the user of the user device 104.

The sequence of operations begins when the user of the user device 104 attempts to access the website or application of the web or application server 108. In some cases, the user may be prompted to enter their phone number on the website. In some other embodiments, the user may be prompted to provide their name and email address instead of the phone number. In some other embodiments, the user may be prompted to provide their name, the bank identification number (BIN), the last four digits of their credit card account number, and their email or phone number. At 206 the user will enter (via the user device 104) their phone number (or other identification data listed above) and that is sent to the web or application server 108. Alternatively, instead of the phone number, or the other data entries mentioned above, being sent, in some embodiments, a hashed version of the phone number, or other data, can be sent to the web or application server 108. For example, a hashing algorithm known to the user device 104, the web or application server 108, the switching and authentication device 110, and the card issuer server 112 can be used. The hashed phone number, or other data, can then be sent to any of the parties and they will be able to decrypt the hashed phone number to determine the actual number. In some embodiments, the web or application server 108 is integrated with a third party server 202 which handles communications between the web or application server 108 and the authentication frontend server 204 and switching and authentication device 110. At 208, the web or application server 108 hands the phone number, or other data, off to the third party server 202, which then forwards the phone number data to the switching and authentication device 110.

At 212, the switching and authentication device 110 then takes the phone number, or other data, (e.g., an un-hashed or a hashed version of the phone number, as the switching and authentication device 110 is aware of the hashing algorithm that was used) and sends a request to one or more card issuer servers 112 (e.g., that also is aware of the hashing algorithm, if one is used) associated with corresponding card issuers. The request includes a query as to whether any of the card issuer servers 112 has a user account associated therewith that corresponds to the phone number, user's name, email address, BIN and last four digits of the credit card, or phone number. That is, the query questions whether the user has a user account with any of the card issuer servers 112 where the user used their phone number, or any other data mentioned above, to identify themselves for the account.

At 214, the switching and authentication device 110 connects with one or more mobile network operators and performs a mobile network operator (MNO) check of the phone number (e.g., hashed or un-hashed) and at 216, the card issuer servers 112 check to see if they have an account associated with the phone number, and if so, if the user has a contactless card (e.g., contactless credit card) associated with their account. In some embodiments, the card issuer servers 112 involve multiple issuers, such as multiple banks or credit card companies. Each credit card company or bank will check to see if they have a user account associated with the phone number. If so, they will check to see if the accounts have any contactless cards associated therewith that are capable of sending encrypted data for verifying their identity.

At 218, the card issuer servers 112 will send a list of the contactless cards associated with the user accounts that are capable of sending encrypted data for identity verification to the switching and authentication device 110. For example, if the user has two credit cards associated with the card issuer server 112 that are also associated with the phone number, the card issuer server 112 will send a list of the two cards and include at least a portion of their primary account number (e.g., the last four digits of each card) to the switching and authentication device 110. At 220, the switching and authentication device 110 is to send the list of card issuers for which the user has an account, along with a list of their contactless cards capable of performing identity verification, to the third party server 202. At 222, the third party server 202 will send a message to the switching and authentication device 110 to create a session identifier (session ID) for an authentication session that will take place thereafter. At 224, the switching and authentication device 110 then sends the session ID (also referred to as a token) to the third party server 202.

At 226, the third party server 202 sends a short messaging service (SMS) or multi-media messaging service (MMS) creation request to the switching and authentication device 110 for the switching and authentication device 110 to send an SMS or MMS with a universal link to the phone number associated with the user. The universal link, when interacted with (e.g., selected) by the user, will cause their mobile device or phone to prompt the user to tap their contactless card to their phone to transfer encrypted data from the contactless card 102 to the user device 104. In some embodiments, before the third party server 202 sends the SMS message with the universal link, the third party server 202 may send the authentication frontend server 204 another SMS message indicating that a universal link is coming, the message also including a notification that the user will be prompted to tap their contactless card 102 to the user device 104 or their smartphone associated with the phone number. In some embodiments, the universal link can include a uniform resource locator (URL).

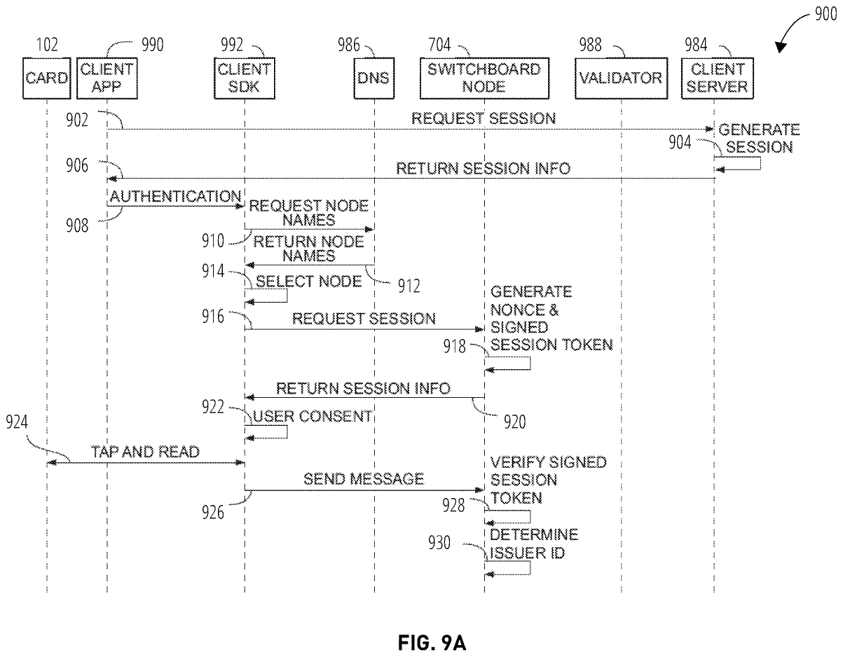

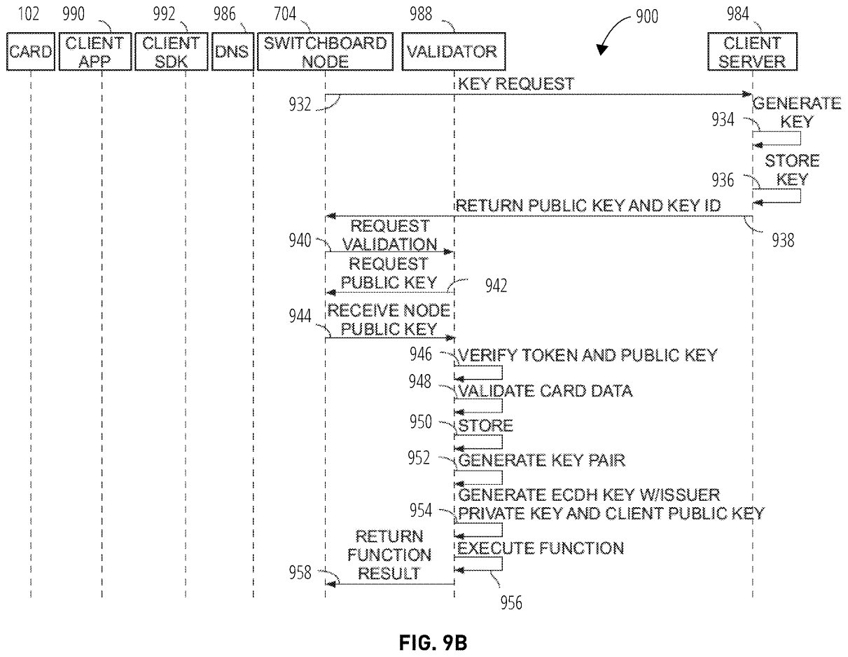

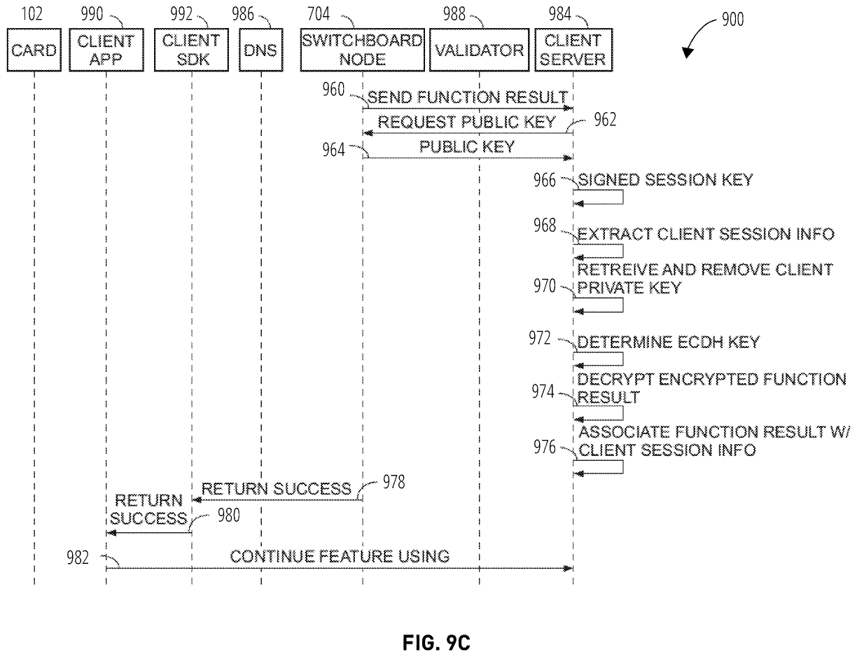

At 228, the switching and authentication device 110 generates the universal link and associates the link with the session ID, so it is clear which session ID any encrypted data is associated with. There are several methods by which the switching and authentication device 110 can generate the universal link. For example, in some embodiments, the client server 984, described below in FIG. 9A, can generate the universal link at operation 904. The universal link is created with a unique identifier, that allows it to look up the original session from the cli ent server 984 as needed. This will usually be a convention based URL route, with the unique identifier embedded within. As an example, baseurl.com/some/route/12345 is a URL where “baseurl.com” is the domain, “/some/route/” is a convention based routing path, and “12345” is the unique identifier for the transaction.

At 230, the switching and authentication device 110 sends the universal link (e.g., in an SMS or MMS message) to the user device 104. In some embodiments, the user device 104 is a desktop, laptop or device other than a smart phone, and the SMS or MMS message including the universal link is sent to the user's phone and not the user device 104. In this example, the user device 104 is both the user's phone associated with the phone number and is the device being used to access the web or application server 108.

At 232, the user interacts with the universal link in the SMS or MMS message (e.g., selects the universal link on their phone screen) and initiates the process for transferring encrypted data from the contactless card 102 to the user device 104. By selecting the universal link, the user device 104 establishes a connection with the authentication frontend server 204 using the session ID. In some embodiments, the user device is to sent the encrypted data back to the switching and authentication device 110, which then forwards the encrypted data to the authentication frontend server 204, including the session ID.

FIG. 2B is a continuation of the flow diagram 200 from FIG. 2A. At 234, after the connection between the user device 104 and the authentication frontend server 204 has been established, the authentication frontend server 204 and the switching and authentication device 110 communicate to request and retrieve the session using the session ID. Next, the authentication frontend server 204 is configured to query the user for a contactless card to select for authentication. For example, in one implementation, at 236, the authentication frontend server 204 causes a list of contactless cards to be displayed on the user device 104, the list of cards is provided from the card issuer servers 112 and includes contactless cards that are owned by the user that are enabled for transferring encrypted data to the user device 104. At 238, the user is prompted on the user device 104 by the authentication frontend server 204 to fetch one of the displayed cards and at 240, the user is presented with terms and conditions from the card issuers on the user device 104.

At 242, the user then taps one of the contactless cards 102 from the list to the user device 104, and accepts the terms and conditions on the user device 104 screen. The user can also select on the user device 104 which of the contactless cards 102 the user will be tapping. At 244, when the user taps the contactless card to the user device 104, the user device 104 conducts a wireless read (e.g., an NFC data exchange format (NDEF) read, or another read using BlueTooth® low energy (BLE), wireless fidelity (Wi-Fi), radio frequency identification (RFID), barcode scan, QR code scan, etc.) of the contactless card and passes the encrypted data from the contactless card 102 to the user device 104 and then to the authentication frontend server 204.

At 246, the authentication frontend server 204 then sends the encrypted data to the switching and authentication device 110 which then routes the encrypted data (with the session ID) to the appropriate authentication server. In some embodiments, the authentication server is a global authentication server where multiple banks use the same authentication server to perform authentication. Alternatively, each bank or card issuer can have their own separate authentication server to verify the encrypted data. The validation request is sent to the switching and authentication device 110 and thereafter the card issuer server 112 associated with the contactless card that was tapped.

At 248, the encrypted data is decrypted by the card issuer server 112 associated with the contactless card 102. If the encrypted data does not match expected encrypted data, the session ends and the user device 104 is not permitted to access the website. The user will need to try a different card.

At 250, the encrypted data is authenticated and it is confirmed that the encrypted data corresponds to expected data for the contactless card that was tapped. In this case, various personal data associated with the user is gathered by the card issuer server 112 and sent to the switching and authentication device 110 for routing back to the web or application server 108. The personal data associated with the user can include the first and last name, birthdate, address of the user or the primary account number (PAN) and expiry of the contactless card 102. At 252, a successful validation process is logged by the switching and authentication device 110 for billing and logging purposes.

At 254, the validation result along with the personal data of the user is sent from the switching and authentication device 110 to the authentication frontend server 204. At 256, the personal data of the customer is returned to the third party server 202 for exchanging with the web or application server 108. At 258, the personal data, including the user's first and last name, birthdate, address, primary account number (PAN) and expiry of their card, is passed to the web or application server 108 which can be used by the web or application server 108 to automatically create an account for the user associated with the user device 104 and the contactless card 102. The account is created with the web or application server 108 and therefore creates an account with the website or application hosted by the web or application server 108.

At 260, the user continues to access services of the web or application server 108, including, for example, booking a hotel, renting a product, or any other suitable services. This may include the user account being created on the web or application server 108 or the user booking a hotel, purchasing a good or service, or any other suitable experience, as a guest, and the personal information shared with the web or application server 108 to check out, without creating an account for the user.

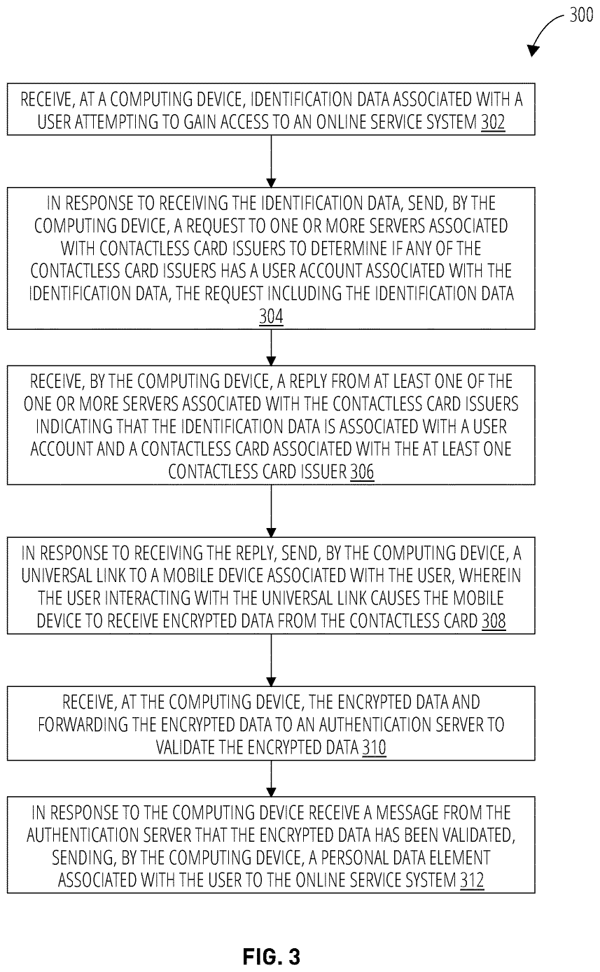

FIG. 3 is a flow chart illustrating operations in an example method 300 according to some embodiments of the present disclosure. For example, as shown at block 302, method 300 includes receiving, at a computing device, identification data (e.g., a phone number or hashed phone number as discussed above) associated with a user attempting to gain access to an online service system. As shown at block 304, the method 300 includes, in response to receiving the identification data, sending, by the computing device, a request to one or more issuer servers associated with contactless card issuers to determine if any of the contactless card issuers has a user account associated with the identification data, the request including the identification data. As shown at block 306, the method 300 includes receiving, by the computing device, a reply from at least one of the one or more issuer servers associated with the contactless card issuers indicating that the identification data is associated with a user account and a contactless card associated with the at least one contactless card issuer.

As shown at block 308, the method 300 includes in response to receiving the reply, sending, by the computing device, a universal link to a mobile device associated with the user, wherein the user interacting with the universal link causes the mobile device to receive encrypted data from the contactless card. As shown at block 310, the method 300 includes receiving, at the computing device, the encrypted data and forwarding the encrypted data to an authentication server to validate the encrypted data. As shown at block 312, the method 300 includes, in response to the computing device receiving a message from the authentication server that the encrypted data has been validated, sending, by the computing device, a personal data element associated with the user to the online service system.

In some embodiments, the identification data associated with the user includes a name of the user and a phone number of the mobile device or an address associated with the user. In some embodiments, the online service system is a website with which the user is attempting to create a user account. In some embodiments, the computing device is part of a switching and authentication network configured to route data from the contactless card and the online service system to the authentication server and the one or more issuer servers associated with the contactless card issuers.

In some embodiments of the method 300, sending the universal link to the mobile device includes sending a short message service (SMS) message to the mobile device with a universal resource locator (URL) for the user to interact with. In some other embodiments, in response to the user interacting with the URL, the mobile device is caused to prompt the user to tap their contactless card to their mobile device to transmit the encrypted data from the contactless card to the mobile device, which then forwards the encrypted data to the computing device.

In some embodiments, the reply includes a list of contactless cards associated with the user account that are enabled to communicate with the computing device. In some embodiments, the user is prompted with the list and instructed to tap one of the contactless cards on the list. In some embodiments, the authentication server is associated with the contactless card issuer of the contactless card selected by the user to be tapped to the mobile device.

In some embodiments, the method 300 further comprises receiving, from a server associated with the contactless card issuer corresponding to the contactless card that the user tapped to the mobile device, the personal data element associated with the user. In some embodiments, the personal data element includes information related to the user's first and last name, birthdate, account address, primary account number, and expiry.

Functions described herein can be performed by a processing circuit executing instructions. The instructions can be executable instructions stored in a non-transitory computer-readable storage medium. The functions can be embodied as the executable instructions stored on the non-transitory computer-readable storage medium. The computer-readable storage medium can then be accessed by a processing circuit and the instructions stored therein can be executed to perform operations described herein.

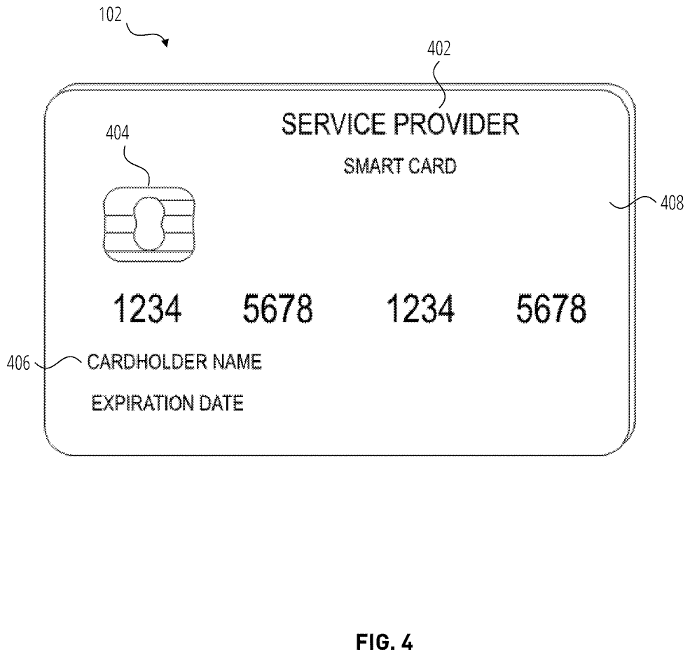

FIG. 4 illustrates an example configuration of a contactless card 102 from FIG. 1, which may include a contactless card, a payment card, such as a credit card, debit card, or gift card, issued by a service provider as displayed as service provider indicia 402 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 408, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

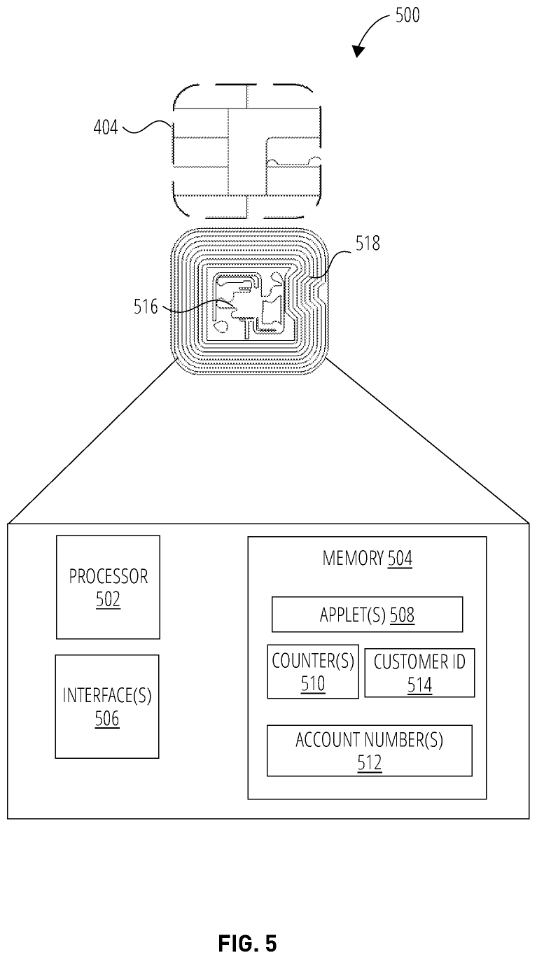

The contactless card 102 may also include identification information 406 displayed on the front and/or back of the card, and a contact pad 404. The contact pad 404 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 5. These components may be located behind the contact pad 404 or elsewhere on the substrate 408, e.g. within a different layer of the substrate 408, and may electrically and physically coupled with the contact pad 404. The contactless card 102 may also include a magnetic strip or tape, which may be located on the back of the card (not shown in FIG. 4). The contactless card 102 may also include a Near-Field Communication (NFC) device coupled with an antenna capable of communicating via the NFC protocol. Embodiments are not limited in this manner.

As illustrated in FIG. 4, the contact pad 404 of contactless card 102 may include processing circuitry 516 for storing, processing, and communicating information, including a processor 502, a memory 504, and one or more interface(s) 506. It is understood that the processing circuitry 516 may contain additional components, including processors, memories, error and parity/CRC checkers, data encoders, anticollision algorithms, controllers, command decoders, security primitives and tamperproofing hardware, as necessary to perform the functions described herein.

The memory 504 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 504 may be encrypted memory utilizing an encryption algorithm executed by the processor 502 to encrypted data.

The memory 504 may be configured to store one or more applet(s) 508, one or more counter(s) 510, a customer identifier 514, and the account number(s) 512, which may be virtual account numbers. The one or more applet(s) 508 may comprise one or more software applications configured to execute on one or more contactless cards, such as a Java® Card applet. However, it is understood that applet(s) 508 are not limited to Java Card applets, and instead may be any software application operable on contactless cards or other devices having limited memory. The one or more counter(s) 510 may comprise a numeric counter sufficient to store an integer. The customer identifier 514 may comprise a unique alphanumeric identifier assigned to a user of the contactless card 102, and the identifier may distinguish the user of the contactless card from other contactless card users. In some examples, the customer identifier 514 may identify both a customer and an account assigned to that customer and may further identify the contactless card 102 associated with the customer's account. As stated, the account number(s) 512 may include thousands of one-time use virtual account numbers associated with the contactless card 102. An applet(s) 508 of the contactless card 102 may be configured to manage the account number(s) 512 (e.g., to select an account number(s) 512, mark the selected account number(s) 512 as used, and transmit the account number(s) 512 to a mobile device or a user device 104 for autofilling by an autofilling service.

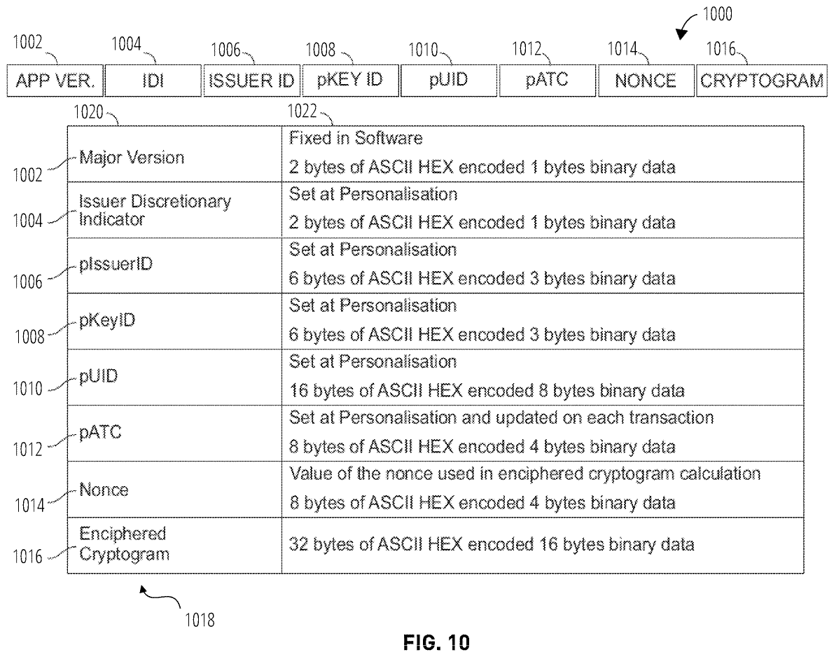

In some embodiments, the memory 504 can include (e.g., have stored therein) the data from the fields shown in FIG. 10. The processor 502 can then use the data from the fields to generate the message 1000 as described herein.

The processor 502 and memory elements of the foregoing exemplary embodiments are described with reference to the contact pad 404, but the present disclosure is not limited thereto. It is understood that these elements may be implemented outside of the contact pad 404 or entirely separate from it, or as further elements in addition to processor 502 and memory 504 elements located within the contact pad 404.

In some examples, the contactless card 102 may comprise one or more antenna(s) 518. The one or more antenna(s) 518 may be placed within the contactless card 102 and around the processing circuitry 516 of the contact pad 404. For example, the one or more antenna(s) 518 may be integral with the processing circuitry 516 and the one or more antenna(s) 518 may be used with an external booster coil. As another example, the one or more antenna(s) 518 may be external to the contact pad 404 and the processing circuitry 516.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 518, processor 502, and/or the memory 504, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 508 may be added to contactless cards to provide a one-time password (OTP) for multifactor authentication (MFA) in various mobile application-based use cases. Applet(s) 508 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 508 may be configured to encode the OTP as an NDEF type 4 well known type text tag. In some examples, NDEF messages may comprise one or more records. The applet(s) 508 may be configured to add one or more static tag records in addition to the OTP record.

In some examples, the one or more applet(s) 508 may be configured to emulate an RFID tag. The RFID tag may include one or more polymorphic tags. In some examples, each time the tag is read, different cryptographic data is presented that may indicate the authenticity of the contactless card. Based on the one or more applet(s) 508, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 510 may be configured to increment. In some examples, each time data from the contactless card 102 is read (e.g., by a mobile device), the counter(s) 510 is transmitted to the server for validation and determines whether the counter(s) 510 are equal (as part of the validation) to a counter of the server.

The one or more counter(s) 510 may be configured to prevent a replay attack. For example, if a cryptogram has been obtained and replayed, that cryptogram is immediately rejected if the counter(s) 510 has been read or used or otherwise passed over. If the counter(s) 510 has not been used, it may be replayed. In some examples, the counter that is incremented on the card is different from the counter that is incremented for transactions. The contactless card 102 is unable to determine the application transaction counter(s) 510 since there is no communication between applet(s) 508 on the contactless card 102.

In some examples, the counter(s) 510 may get out of sync. In some examples, to account for accidental reads that initiate transactions, such as reading at an angle, the counter(s) 510 may increment but the application does not process the counter(s) 510. In some examples, when the user device 104 is woken up, NFC may be enabled and the user device 104 may be configured to read available tags, but no action is taken responsive to the reads.

To keep the counter(s) 510 in sync, an application, such as a background application, may be executed that would be configured to detect when the mobile user device 104 wakes up and synchronize with the server of a banking system indicating that a read that occurred due to detection to then move the counter(s) 510 forward. In other examples, Hashed One Time Password may be utilized such that a window of mis-synchronization may be accepted. For example, if within a threshold of 10, the counter(s) 510 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 510 increases in the appropriate sequence, then it possible to know that the user has done so.

The key diversification technique described herein with reference to the counter(s) 510, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format. The authentication message discussed above is the encrypted data referred to in FIG. 1-FIG. 3.

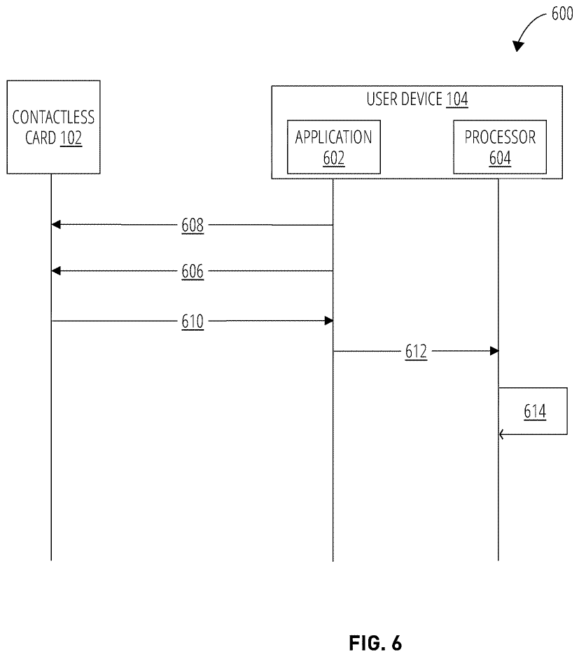

FIG. 6 is a flow diagram illustrating an example sequence for providing authenticated access according to one or more embodiments of the present disclosure. Sequence flow 600 may include contactless card 102 and user device 104, which may include an application 602 and processor 604. This figure describes how the encrypted data is passed from the contactless card 102 to the user device 104.

At line 608, the application 602 communicates with the contactless card 102 (e.g., after being brought near the contactless card 102). Communication between the application 602 and the contactless card 102 may involve the contactless card 102 being sufficiently close to a card reader (not shown) of the user device 104 to enable NFC data transfer between the application 602 and the contactless card 102.

At line 606, after communication has been established between user device 104 and contactless card 102, contactless card 102 generates a message authentication code (MAC) cryptogram. In some examples, this may occur when the contactless card 102 is read by the application 602. In particular, this may occur upon a read, such as an NFC read, of a near field data exchange (NDEF) tag, which may be created in accordance with the NFC Data Exchange Format. For example, a reader application, such as application 602, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 602 may be configured to transmit a request to contactless card 102, the request comprising an instruction to generate a MAC cryptogram.

At line 610, the contactless card 102 sends the MAC cryptogram to the application 602. In some examples, the transmission of the MAC cryptogram occurs via NFC, however, the present disclosure is not limited thereto. In other examples, this communication may occur via Bluetooth, Wi-Fi, or other means of wireless data communication. At line 612, the application 602 communicates the MAC cryptogram to the processor 604.

At line 614, the processor 604 verifies the MAC cryptogram pursuant to an instruction from the application 602. For example, the MAC cryptogram may be verified, as explained below. In some examples, verifying the MAC cryptogram may be performed by a device other than user device 104, such as a server of a banking system in data communication with the user device 104. For example, processor 604 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

FIG. 7 illustrates an example of a switching system 700 in accordance with the embodiments discussed herein. The system 700 includes the switching and authentication device 110 discussed above in FIG. 1 through FIG. 3. The system 700 includes additional devices and systems configured to enable contactless card issuers to tap-to-card services. Specifically, system 700 enables any number of issuer systems to provide card services to their clients through a switching fabric, i.e., the switchboard system in a secure and safe manner.

In embodiments, the switchboard system includes one or more nodes 704 configured to perform routing operations. Each switchboard node 704 may include a session and nonce generator 706, a message router 708, an authentication 710, an operation data 712 store, and a metrics store 714. Further, each of the nodes may be configured the same and share configurations, but each switchboard node 704 may independently process and route messages and requests to the appropriate systems, such as the merchant systems and issuer systems. Each of the nodes 704 is configured to act as a broker of trust between an issuer system, the merchant system 722, and/or validation system 724, for example. Each switchboard node 704 is configured to route each message to the correct issuer system while maintaining data security. For example, a switchboard node 704 may route a message between an issuer system and a merchant system while the node cannot access the private data in the message. The issuer system described herein can include the card issuer server 112 and the merchant system 722 can include the web or application server 108.

The switchboard system 700 may be configured as a server system with a collection of hardware, software, and networking components that work together to provide client services. Hardware components may include one or more server computers, storage devices, and network adapters. The server computers are configured to run server applications, such as those executable on each of the nodes 704. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

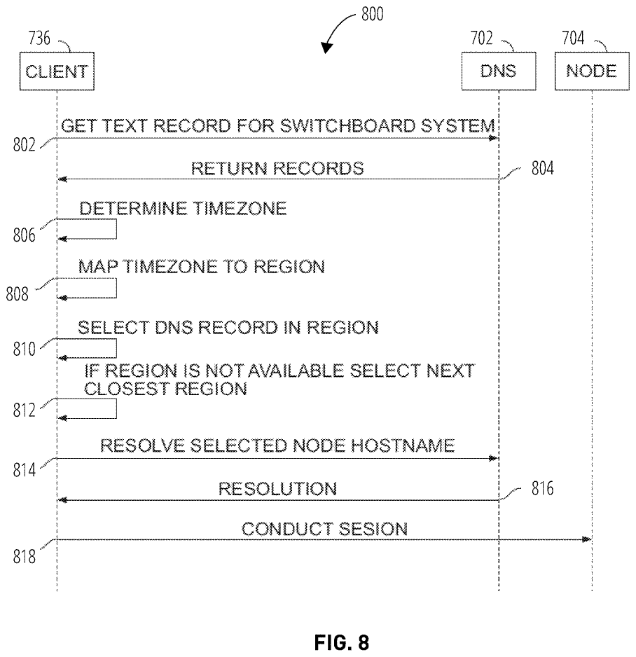

In some embodiments, the nodes 704 may operate in a cloud-based computing environment, e.g., a collection of hardware, software, and networking components that enable the delivery of cloud computing services. The switchboard nodes 704 and the computing services are delivered over the Internet and can be accessed from anywhere in the world with an Internet connection. In embodiments, client 736 may access a switchboard node 704 through DNS 702 or Domain Name System (DNS). The DNS 702 is a hierarchical and distributed naming system for computers, services, and other resources connected to the Internet or other networks. It associates various information with domain names assigned to each registered participant. In one example, the DNS 702 may translate a name known to software executing on a client 736 to route data to one or more of switchboard node 704 of the switchboard system. In embodiments, the DNS 702 may generate a number, such as an Internet Protocol (IP) address, an address record (A-record), or another Hostname (C-name record). FIG. 8 illustrates one example sequence 800 for a client to identify and resolve an identifier for one of the nodes 704 of the switchboard system. At a high level, the DNS 702 translates known domain names to numerical Internet Protocol (IP) addresses needed for locating and identifying computer services and devices with the underlying network protocols. Clients use the global DNS system to select the best node to use, as discussed in sequence 800.

In embodiments, a client 736 communicates with the switchboard system to perform one or more of the partner services 732, such as conducting a transaction with a merchant, validating the customer, or other tap-to functions. Once client 736 identifies a switchboard node 704 and resolves an address to communicate with switchboard node 704, client 736 may send one or more messages to switchboard node 704 to authenticate and perform the operation. The switchboard node 704 includes an authentication 710 function that is configured to authenticate the client 736. In embodiments, the client 736 sends a message or authorization request to the switchboard node 704 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 65535 | Client ID | Individual identifier of client |
| GReyx5BuEAaE72bWbFZJfHRL8Dbt1Uum | Client Key | Randomly assigned key |

The switchboard node 704 may authorize or authenticate the client 736 or user, and the switchboard node 704 may utilize the additional components, such as the session and nonce session and node generator 706 and message router 708, to perform the operations. Note the validation systems validation system 724 never interact with the merchant systems 722, nor vice versa. The nodes node 704 brokers all communication.

In embodiments, the switchboard system may utilize a hyper ledger fabric 720 to manage to synchronize the shared operation data 712 and member management across the network. The hyperledger fabric 720 is distributed ledger framework having a permissioned network model that only authorized participants can join the network and access the data that is stored on a ledger.

In embodiments, the hyperledger fabric 720 may be generated by creating one or more sets of peers, an ordering service, and a channel. Once the network is created, system 700 deploys chaincode to the network, or node 704 is permitted to access the fabric. The chaincode is the code that runs on the blockchain and executes the network control 726 and operation data 712 logic code. Once the chaincode is deployed, each of the switchboard nodes 704 is configured to invoke transactions on the blockchain to add data to the blockchain, e.g., the operational data. A switchboard node 704 or another device can query the ledger to retrieve data. The ledger is a distributed database that stores all the data added to the blockchain.

All nodes 704 keep an independently verifiable log of their actions that can be transmitted to a centralized aggregator to build a picture of overall network usage. System 700 can manage network operation data and management at a central level and have a centralized view of network use, aggregated and abstracted to the appropriate level.

FIG. 8 illustrates an example sequence 800 for a client to utilize DNS to resolve and communicate with one or more nodes of a switchboard system, such as system 700. The illustrated sequence 800 includes a client 736, a DNS 702, and a switchboard node 704. At 802, the sequence 802 includes the client 736 sending a request to a default DNS server for a text record switchboard. {domain}. {tld}. The text record may be preconfigured in a client app and/or client SDK. At 804, the DNS 702 returns one or more records. A DNS record structure may include the following:
Root Record:
   Name: switchboard.{domain}.{tld}
   Type: TXT
   Resolution:
      {nodename_1}.{operator_a}.{region_i}.switchboard.{domain}.{tld},
      {nodename_2}.{operator_a}.{region_i}.switchboard.{domain}.{tld},
      {nodename_1}.{operator_b}.{region_ii}.switchboard.{domain}.{tld},
      {nodename_2}.{operator_b}.{region_ii}.switchboard.{domain}.{tld},
      * etc.
   Used For determining where there are active nodes
Node Record:
   Name: {nodename}.{operator}.{region}.switchboard.{domain}.{tld}
   Type: A/AAAA or CNAME
   Resolution: Actual node hostname or IP
   Used For: communicating with a node 704

In embodiments, the client 736 may determine the current timezone at 806. For example, the client app or SDK may utilize a get current timezone function, such as in JavaScript: Intl.DateTimeFormat( ).resolvedOptions( ).timeZone). Embodiments are not limited in this manner, and the app or sdk may determine the timezone via another/different function call. At 808, the client 736 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_York | North America / East | na-e |
| America/Buenos_Aires | South America | sa |
| US/Pacific | North America / West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<->na-w and sa<->na-w and sa<->na-e. This representation is useful for node selection.

At 810, the client 736 may identify or select a DNS record option returned at 804 that is in the region. If there are multiple matches, the client 736 may select one at random. If there's no node available in a region, the client 736 may determine and use a data graph of neighboring regions to select a node in the closest region where a node is available at 812. For example, sa has no node but is connected to na-e where there is a node and so na-e is selected. In some embodiments,

At 814, the client may resolve a selected node's hostname. In embodiments, the client 736 may automatically resolve the hostname using the client's HTTP request default resolver. At 816, the DNS 702 may return a result. And at 818, the client 736 may communicate with a switchboard node 704 and begin the process to interact with the switchboard.

FIG. 9A-FIG. 9C illustrate an example sequence 900 to perform operations between a contactless card and services provided by a card issuer and/or merchant. The illustrated sequence 900 includes actions and communications performed by a contactless card 102, a client 736 including a client app 990 and a client SDK 992, a DNS 986, a switchboard system including one or more nodes 704, a partner services 732 including a merchant and/or validator 988, and control services 734 including a client server 984 or system. In embodiments, the client app 990 may be any application configured to execute on a client 736, such as a banking app, a merchant app, a social media app, a travel app, a gaming app, a productivity app, an entertainment app, and so forth. In embodiments, the client app 990 includes a web browser to provide websites and pages. The client app 990 may include and/or utilize the client SDK 992, which may be a set of instructions that enable the client app 990 to communicate with other components of the switchboard system.

In embodiments, as shown in FIG. 9A, at 902 the client 736 including the client app may send a request and establish a session with a client server 984 such that a result may be associated with the correct client device or user. The request establishes a relationship between the client device and client server, which may be an issuer server. At 904, the client server 984 generates a session and CLIENT SESSION INFORMATION. At 906, the client server 984 returns the session information, e.g., the CLIENT SESSION INFORMATION. In embodiments, the CLIENT SESSION INFORMATION may be the Client implementation-specific user session identification information.

At 908, the client 736 may initiate a contactless card authentication process with the client 736. For example, the client 736 may call a function and/or pass information to the client 736 to initiate authentication via a contactless card 102. At 910-914, the client 736 may utilize DNS to identify a node and establish communication with the node. Specifically, at 910, the client 736 including the client SDK 992 may send a request for switchboard hostnames, and at 912 the the DNS 986 may return information including one or more hostnames. At 914, the client 736 may determine a switchboard node to communicate. FIG. 8 illustrates an example of a more detailed sequence of the process to establish communication with a switchboard node 704.

At 916, the client 736 may send a request for a session to the switchboard system 700. In embodiments, the request for a session may be for a function request in the format <FUNCTION REQUEST>. In embodiments, the FUNCTION REQUEST may be the data/function that the client 736 would like to request once a contactless card 102 has been validated. The function could be for any service discussed herein, e.g., authenticate the user, perform a transaction, request autofill data, etc. At 918, switchboard system 700 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 102. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard system 700 private key. The switchboard system 700 may include a NODE PUBLIC/PRIVATE KEY, which is a keypair used to sign and validate JWTs.

At 920, the switchboard system 700 may return session information to the client 736. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 922, the client SDK 992 may determine and/or receive user consent to the terms of service. In one example, the client SDK 992 captures and records the user consent to <FUNCTION TOS> on <CONSENT DATE> with <TOS VERSION>. The CONSENT DATE may be the timestamp for the user's consent to the TOS.

At 924, the client 736 exchanges one or more messages with a contactless card. In one example, the exchange may be based on the contactless card being tapped to a client device. In embodiments, the client SDK 992 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message Tag | D1 (only record) |
| 01 | Length of Record Type | 01 |
| 02 | Length of Record | 33 |
| 03 | text record type | 54 |
| 04 | Length of | 02 |
| | Language | |
| 05-06 | Language | 65 6E (“en”) |
| 07 . . . 0E | NONCE | 8 bytes of ASCII HEX encoded 4 bytes binary data |
| 0F . . . 12 | Session Indicators | 4 bytes of ASCII HEX encoded 2 bytes binary data |
| 13 . . . 16 | Control Indicators | 4 bytes of ASCII HEX encoded 2 bytes binary data |
| 17 . . . 26 | Update Date | 16 bytes of ASCII HEX encoded 8 bytes binary |
| | creation Time | data - represents 64 bit unix timestamp |
| 27 . . . 36 | Update MAC | MAC to protect control indicators - 16 bytes of |
| | | ASCII HEX encoded 8 bytes binary data |

The updated MAC may be calculated to protect the control indicators in embodiments Specifically, The MAC M is determined by calculating a MAC over the 10 bytes of the update data U with the Update MAC Card Key (MCK), as described in FIG. 10, message 1000.

At 924, the contactless card may generate and provide a message to the client's device including the client SDK 992. The data in the message may be utilized by the system discussed herein to perform the function requested. One example of the message is illustrated and discussed in FIG. 10, message 1000.

At 926, the client including the client SDK 992 may send a message and information to the switchboard system 700. The message may be the message received from the contactless card 102, e.g., message 1000. In addition, the client SDK 992 may send the consent date, the TOS version, and the signed session token to the switchboard system 700. The switchboard system 700 may utilize the information to ensure the session is valid. At 928, the switchboard system 700 verifies the signed session token is valid, e.g., is the previously provided signed session token and includes the nonce previously generated and is in the message.

In some embodiments, the switchboard system 700 is configured to determine which issuer system or client-server it should route the message to for processing. At 930, the switchboard system 700 may determine the issuer ID by extracting it from the message received from the contactless card 102 via the client SDK 992. As mentioned, the issuer ID identifies the issuer of the contactless card 102.

FIG. 9B continues the sequence 900 from FIG. 9A. In embodiments, the switchboard system 700 is configured to generate and communicate secure communications with the issuer system, e.g., the client server 984 and the validator 988. At 932, the switchboard system 700 sends a request for a key to the client server 984. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 934, the client server 984 generates a portion of the key. In some instances, the client server 984 may generate half of the ECDH key for encryption/decryption of PII. Specifically, the client server 984 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 936, the client-server 984 stores the generated portion of the key in storage. Specifically, the client server 984 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 984 may return the public key portion to the switchboard system 700 with the KEY ID at 938. The switchboard system 700 may store the public key portion with the KEY ID for later use, e.g., generation of the ECDH key. At 940, the switchboard system 700 may request a validation to be performed by the validator 988. In one example, the switchboard system 700 may send a request validation as Request validation <MESSAGE>, <SIGNED SESSION TOKEN>, <CLIENT EC PUBLIC KEY>, <CONSENT DATE>, and the <TOS VERSION>. The validator 988 may make an out-of-band request back to the switchboard system 700 for the public key to verify the session at 942. At 944, the switchboard system 700 may provide the node's public key, i.e., <NODE PUBLIC KEY>. Further at 946, the validator 988 may utilize the node's public key to verify the secure session token.

In embodiments, the validator 988 may validate the message at 948. In embodiments, the validator 988 may perform a number of validations including ensuring the nonce in the message is correct along with additional information, such as the card's unique identifier (pUID), and the counter value (pATC).

At 950, the validator 988 may store information associated with the session. For example, validator 988 may store the <CONSENT DATE> with the <TOS VERSION> and the <PUID>. The validator 988 may also generate another portion of the key, e.g., the ECDH key.

For example, the 988 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 954, the validator 988 may generate the complete ECDH key. For example, the validator 988 generates the <ECDH KEY> from <ISSUER EC PRIVATE KEY> and <CLIENT EC PUBLIC KEY>. The ECDH KEY is the final key generated using ECDH key negotiation.

The validator 988 may utilize the ECDH KEY to encrypt data for the function. For example, if the validator 988 validates the message in some instances, the validator 988 may execute a function request to create a function result and encrypt the result with the ECDH KEY at 956. For example, the validator 988 may Execute <FUNCTION REQUEST> to create <FUNCTION RESULT> and encrypt it with the <ECDH KEY>. The function result may be any result based on the requested function, e.g., verification of the card.

At 958, the validator 988 may return the function result to the switchboard system 700. In some instances, the function result is returned encrypted. For example, the validator 988 may return the <ENCRYPTED FUNCTION RESULT> and the <ISSUER EC PUBLIC KEY>.

FIG. 9C continues the sequence 900 from FIG. 9B. In embodiments, at 960 the switchboard system 700 sends the function result to the client server 984 to process the result. In one example, the switchboard system 700 may send the <ENCRYPTED FUNCTION RESULT>, <KEY ID>, <ISSUER EC PUBLIC KEY>, and <SIGNED SESSION TOKEN>. At 962 and 964, the client server 984 may make a request for and receive the public key from the switchboard system 700. In some instances, the exchange may be performed via out-of-band communication channels. The public key for the node may be <NODE PUBLIC KEY>. The public key may be used to verify the sender of the function result, etc. At 966, the client server 984 may verify the signed session key with the node's public key <NODE PUBLIC KEY> to verify the sender of the information. At 968, the client server 984 may extract client information from the signed session token. For example, the client server 984 may Extract <CLIENT SESSION INFO> from <SIGNED SESSION TOKEN>, i.e., extracting the client implementation-specific user session identification information.

Further, at 970, the client server 984 may retrieve the client's private key with the KEY ID. Specifically, the client server 984 may get and remove the <CLIENT PRIVATE KEY> from cache using the <KEY ID>. At 972, the client server 984 may generate or compute the ECDH key. For example, the client server 984 may compute the <ECDH KEY> with the <CLIENT PRIVATE KEY>+<ISSUER EC PUBLIC KEY>. The client server 984 may decrypt the function result with the computed key at 974. Specifically, the client server 984 may decrypt the <ENCRYPTED FUNCTION RESULT> with the <ECDH KEY> to determine the <FUNCTION RESULT>. At 976, the client server 984 associates the function result with the session.

In embodiments, the switchboard system 708 may return whether the function result was successfully completed or not at 978 to the client SDK 992. Further at 980, the client SDK 992 may notify the client app 990 of the result. At 982, the client app 990 may utilize the feature. For example, the 982 may communicate with the client server 984 to continue the feature using the <CLIENT SESSION INFO> to fetch the redacted <FUNCTION RESULT>.

FIG. 10 illustrates an example of a message 1000 that may be communicated by a contactless card to perform the functions described herein, such as those discussed in FIG. 9A through FIG. 9C. The message 1000 includes the encrypted data discussed in FIG. 1 through FIG. 3. One or more of the fields in message 1000 may also be utilized to route the message 1000 through the switchboard system and perform authentication/validation techniques.

In embodiments, the message 1000 includes an applet version 1002 field, an issuer discretionary indicator 1004 field, an Issuer Identifier 1006 field, a pKey ID 1008 field, a pUID 1010 field, a pATC 1012 field, a nonce 1014 field, and an encrypted cryptogram 1016.

In embodiments, the fields may be in plain text or encrypted. For example, the applet version 1002 field may include an applet version in plain text. The applet version indicates which applet version is installed on a contactless card and may be used by the other systems to determine how to process the message 1000 when communicated. For example, different Applet versions require different validation logic, e.g., an older message may be routed through the issuer system to perform various operations for validation, while a newer message may be routed through the switchboard system to perform the various operations, including validation.

In embodiments, the message 1000 includes an issuer discretionary indicator 1004 field that may include issuer data and set at the time of personalization. In addition, the message 1000 includes an Issuer Identifier 1006 field that may include a unique ID assigned to the entity issuing the card, e.g., the issuer. For example, when joining the system, each issuer may be assigned a unique identifier during an onboarding operation. The issuer ID can be used by the switchboard system 708 to route a message and its contents to the appropriate services that are associated with that particular issuer.

In embodiments, the message 1000 includes a pKey ID 1008 field. In some instances, the pKey ID 1008 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs.

The message 1000 may include a pUID 1010 field, including a card unique identifier assigned to the contactless card at personalization time. The pUID 1010 field data may be a combination of alphanumeric characters used to identify each card and associated with a user uniquely.

In embodiments, the message 1000 includes a pATC 1012 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1000 is created, a new session key is derived and utilized to generate one or more portions of the message 1000. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1000 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such as a mobile device, during a read operation. For example, in response to the contactless card 102 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth, WiFi, and the like. In some instances, a message may be communicated between a contactless card 102 and a device via wired means, e.g., via the contact pad, and in accordance with the EMV protocol.

As discussed above, the contactless card 102 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 102. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 102 stores the generated application key(s) or UDK(s).

In embodiments, the contactless card 102 utilizes the application key(s) or UDK(s) to generate session keys for each encrypted data is generated. The following is one processing flow that may be performed by the contactless to generate a unique cryptogram session key (ASK).

To generate the ASK, the contactless card 102 computes SKL by encrypting [ATC[2]∥ATC[3]∥‘F0’∥‘00’∥[ATC[0]∥[ATC[1]∥[ATC[2]∥[ATC[3]] with an application key. Further, the contactless card 102 computes SKR by encrypting [ATC[2]∥ATC[3]∥‘OF’∥‘00’∥[ATC[0]∥[ATC[1][ATC[2]∥[ATC[3]] with the application key. Finally, the contactless card 102 concatenates SKL with SKR to form an authentication session key (ASK). In embodiments, the ASK is used to perform operations utilizing the contactless card 102, such as encrypting the cryptographic MAC.

In embodiments, the contactless card 102 also supports session key derivation to generate a unique encipherment session key DESK. The contactless card 102 computes an SKL by encrypting [ATC[2]∥ATC[3]∥‘F0’∥‘00’∥‘00’∥‘00’∥‘00’∥‘00’] with a Data Encryption Key (DEK) or UDK. Further, the contactless card 102 computes SKR by encrypting [ATC[2]∥ATC[3]∥‘0F’∥‘00’∥‘00’∥‘00’∥‘00’∥‘00’] with the DEK or UDK. The contactless card 102 concatenates SKL with SKR to form the Data Encipherment Session Key (DESK).

In embodiments, the contactless card 102 generates encrypted data or a cryptogram utilizing the session keys. Specifically, the contactless card 102 generates a cryptogram C by calculating a MAC over the 32-byte transaction data T using the Authentication Session Key (ASK).

The contactless card 102 may process the data to generate the cryptogram. Specifically, the contactless card 102 divides T into four blocks of 8 bytes of data: T=T1∥T2∥T3∥T4. The contactless card 102 computes B=DES(ASKL) [T1], where is the Data Encryption Standard or another symmetric encryption algorithm, ASKL is a portion of the ASK, e.g., the “left” half of the key. The contactless card 102 computes B=[B XOR T2], and, the contactless card 102 computes B=DES(ASKL) [B], where DES is an encryption algorithm. The contactless card 102 computes B=[B XOR T3], and the contactless card 102 computes B=DES(ASKL) [B]. The contactless card 102 computes B=[B XOR T4], and the contactless card 102 computes B=DES(ASKL) [B]. The contactless card 102 computes B=DES⁻¹(ASKR) [B], where DES⁻¹ is the reciprocal DES operation, and ASKR is a portion of the ASK, e.g., the right half. The contactless card 102 computes the cryptogram C=DES(ASKL) [B].

In embodiments, a contactless card 102 may also encipher the cryptogram to secure the data further. For example, a contactless card 102 may generate an 8-byte random number [RND] and the card computes E1=DES3(DESK) [RND], where DES3 is a symmetric encryption algorithm such as the Triple Data Encryption Standard. The contactless card 102 then computes B=[E1] XOR [C], where C is the cryptogram generated, as discussed above. The contactless card 102 computes E2=DES3(DESK) [B], where B is computed above. Further, the contactless card 102 generates the 16-byte enciphered payload E=[E1]∥[E2].

In embodiments, a device or the contactless card 102 may decrypt the payload E by determining, receiving, or retrieving the payload E. The device computes a RND=DES3⁻¹(DESK) [E1]. The device determines B=DES3⁻¹(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 102 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, the data U is broken into two blocks of 8 bytes of data, where U=U₁∥U₂. Further, operations may be performed on U₁ and U₂.

Embodiments include applying an algorithm to the first portion (U₁) of the data. In one example, a result B may be computed where B=DES(MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

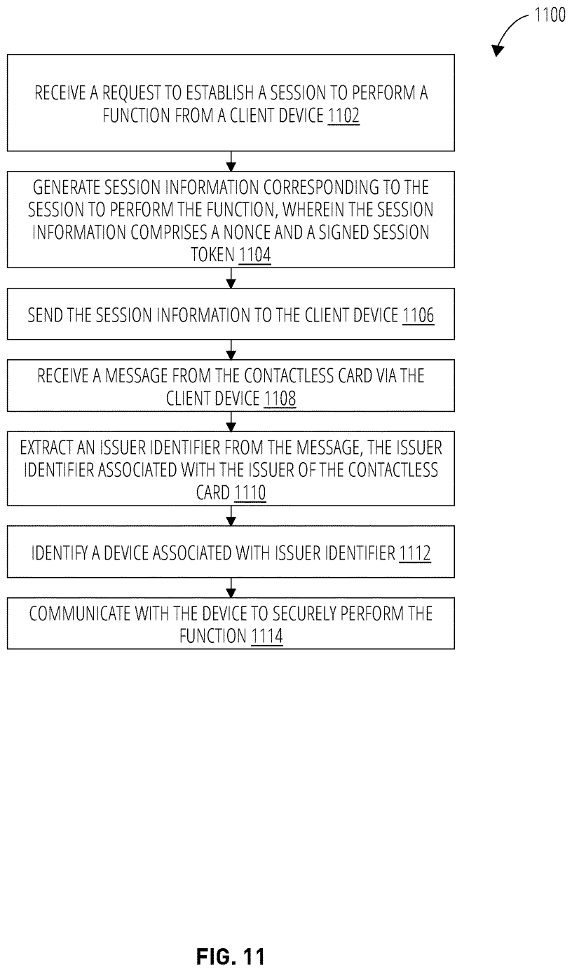

FIG. 11 illustrates an example of method 1100 in accordance with embodiments discussed herein. In block 1102, the method 1100 includes receiving, by a node in a system, a request to establish a session to perform a function from a client device, wherein the function is at least partially performed utilizing a contactless card, such as contactless card 102. In some instances, the node may be one of a plurality nodes of a switchboard system. The node may be previously selected by the sending device via a DNS operation performed.

In block 1104, the method 1100 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1106, method 1100 includes sending the session information to the client device by the node. The client device may communicate with a contactless card to receive data from the card to authenticate and perform a function. In some instances, the client device may send the nonce from the node to the contactless card. The contactless card may utilize the nonce when generating the message to communicate back to the client device. Finally, the node, e.g., incorporates it into a cryptographic portion of the message (see FIG. 10).

In block 1108, method 1100 includes receiving, by the node, a message from the contactless card via the client device. The message may be generated by the contactless card. FIG. 10 illustrates one example of a message 1000. In some embodiments, the node verifies the message. For example, the node may verify a nonce in the message and a signed session token.

In block 1110, method 1100 extracts an issuer identifier from the message by the node, the issuer identifier associated with the issuer of the contactless card. In some instances, the issuer identifier may be in a plaintext format.

In block 1112, method 1100 identifies, by the node, a device associated with the issuer identifier. For example, the node may perform a lookup to determine a server associated with the issuer identifier and the function to be performed.

In block 1114, method 1100 communicates, by the node, with the device to securely perform the function.

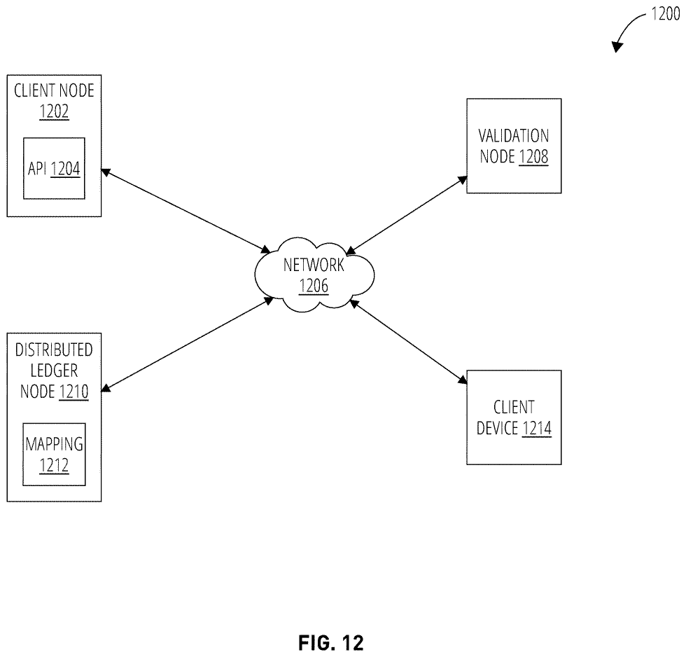

FIG. 12 illustrates a distributed network authentication system 1200 according to an example embodiment. FIG. 12 discloses at least one system that can provide validation and authentication services for authenticating the encrypted data sent by the contactless card 102. As further discussed below, system 1200 can include client node 1202, API 1204, network 1206, distributed ledger node 1210, mapping 1212, and client device 1214. Although FIG. 12 illustrates single instances of the components, system 1200 can include any number of components.

System 1200 can include a client node 1202, which can be a network-enabled computer as described herein. In some examples, client node 1202 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1200.

In some examples, client node 1202 can execute one or more applications, such as software applications, that enable, for example, network communications with one or more components of system 1200, transmit and/or receive data, and perform the functions and processes described herein.

The client node can contain an API 1204. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1204 to interact with the service, such as by performing a remote call to an API for interacting with a web-based service.

API 1204 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1202 can communicate with one or more other components of system 1200 either directly or via network 1206. Network 1206 can comprise one or more of a wireless network, a wired network or any combination of wireless network and wired network, and may be configured to connect the components of system 1200. While FIG. 12 illustrates communication between the components of system 1200 through network 1206, it is understood that any component of system 1200 can communicate directly with another component of system 1200, e.g., without involving network 1206.

System 1200 can include a validation node 1208, which can be a network-enabled computer as described herein. In some examples, validation node 1208 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1200.

In some examples, validation node 1208 can execute one or more applications, such as software applications, that enable, for example, network communications with one or more components of system 1200, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1200 can include a distributed ledger node 1210, which can be a network-enabled computer as described herein. In some examples, distributed ledger node 1210 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1200.

In some examples, distributed ledger node 1210 can execute one or more applications, such as software applications, that enable, for example, network communications with one or more components of system 1200, transmit and/or receive data, and perform the functions and processes described herein.

Distributed ledger node 1210 can containing a mapping 1212. In some examples, mapping 1212 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1200, or the one or more databases can be hosted externally to any component of the system 1200. In some examples, the one or more databases can be contained in the distributed ledger node 1210, and in other examples the one or more databases can be stored outside of distributed edger node 1210 but in data communication with distributed ledger node 1210. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1210. In other examples, the one or more databases can be remote from distributed ledger node 1210 but in data communication with distributed ledger node 1210. Data communication between the one or more databases and distributed ledger node 1210 can be a direct data communication or data communication via a network, such as the network 1206.

In some examples, client node 1202 can be in data communication with distributed ledger node 1210. Distributed ledger node 1210 can contain mapping 1212. Mapping 1214 may include, e.g., a mapping between a validation node address and the validation node 1208, a mapping between a routing number and a validation node address, and/or a mapping between a routing number and validation node 1208. In some examples, mapping 1212 can include a digital signature associated with an entity having permission to validate for a routing number. Based on one or more of these associations, client node 1202 can call validation node for validation and/or provide direction to the client device to reach the appropriate validation node. This can be accomplished by calling a validation API associated with validation node 1208.

In some examples, iterations of the mappings described herein, such as mapping 1212, can also include a software or applet version number. The version number can be used to identify a validation node or validation node address or choose between multiple validation addresses for one validation node.

In some examples, client node 1202 and distributed ledger node 1210 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1210 can update mapping 1212 to reflect a different association between, e.g., a routing number, a validation node address, and a validation node. In some examples, degrees of permissions can be issued. For example, if client node 1202 were to function to route data to validation node 1208 (or other validation nodes), client node 1202 can be given a certain level of permissions. As another example, if distributed ledger node 1210 were to have the capability to update mapping 1212, distributed ledger node 1210 can have a different, higher level of permissions.

System 1200 can include a client device 1214, which can be a network-enabled computer as described herein. In some examples, distributed ledger node 1214 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1200. Client device 1214 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1214 can be in data communication with another network-enabled computer not shown in FIG. 12, such as a smart card (e.g., a contactless card or a contact-based card).

In some examples, client device 1214 can execute one or more applications, such as software applications, that enable, for example, network communications with one or more components of system 1200, transmit and/or receive data, and perform the functions and processes described herein.

In some examples, upon receipt of an authentication request, client device 1214 can call (e.g., via an API) client node 1202. The call can include a routing number and/or an applet or software version number, and client node 1202 can query distributed ledger node 1210 and mapping 1212. Once the query returns the identification of a validation node (e.g., validation node 1208) and/or a validation node address associated with that routing number and/or applet or software version, client node 1202 can reply to client device 1214. Client device 1214 can then proceed with authentication with the validation node. The authentication can be performed by, e.g., the systems and methods described herein, such as by the generation, encryption, transmission, decryption, and validation of a cryptogram as described herein.

In some examples, client node 1202 can be co-resident with validation node 1208. In these examples, client node 1202 can handle the authentication in a single call from client device 1214. In some examples, this can be acceptable only if it is permissible for the full authentication transmission (e.g., a cryptogram as described herein) to be sent to client nodes that are not involved in authentication.

In some examples, if client node 1202 receives, from client device 1214, a routing number that is not handled by its location, client node 1202 can return a code indicating that this routing number is not handled, along with validation node address for the responsible validation node. Client device 1214 can then send the full authentication transmission to validation node 1208 using the received validation node address.

In some examples, client node 1202 can enter the distributed network with different permissions. For example, client node 1202 can be a read-only router of data. As another example, client node 1202 can have permission to send messages to distributed ledger node 1210 updating one or more routing paths for one or more routing numbers. However, client node 1202 would be prevented from updating one or more routing paths for one or more routing numbers for other entities that control other routing numbers which are not associated with client node 1202 or that did not grant this permission. As another example, distributed ledger node 1210 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1202, distributed ledger node 1210, and/or validation node 1208, if security, legal, and/or financial conditions are met, however, delegation is not required.

In some examples, one or more APIs can facilitate communication between components of system 1200 via network 1206. In other examples, one or more APIs are not required. Rather, the components of system 1200 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1208 for authentication, can require storage of the keys in one or more HSMs, to promote key security and ensure that the keys are never entered into memory.

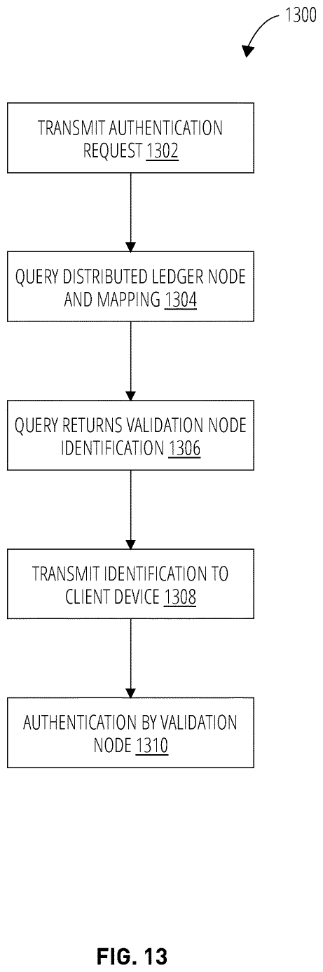

FIG. 13 illustrates a method 1300 performed by a distributed network authentication system according to an example embodiment. For example, the method can be performed by distributed network authentication system 1200 and or by another distributed network authentication system.

In block 1302, a client device can transmit an authentication request to a client node. The authentication request can include, without limitation, a routing number, a software version number, and/or an applet version number. The request can be made by an API call or other communication between the client device and the client node.

In block 1304, after receiving the authentication request, the client node can transmit a query (e.g., via an API call) to a distributed ledger node. The distributed ledger node contain a mapping, and the distributed ledger node can submit the query to the mapping.

In block 1306, the query can return an identification of a validation node and/or a validation node address, and the distributed ledger node can transmit this identification to the client node.

In block 1308, the client node can transmit the identification to the client device. After receiving the identification, the client device can proceed with authentication with the identified validation node and/or validation node address, in block 1310.

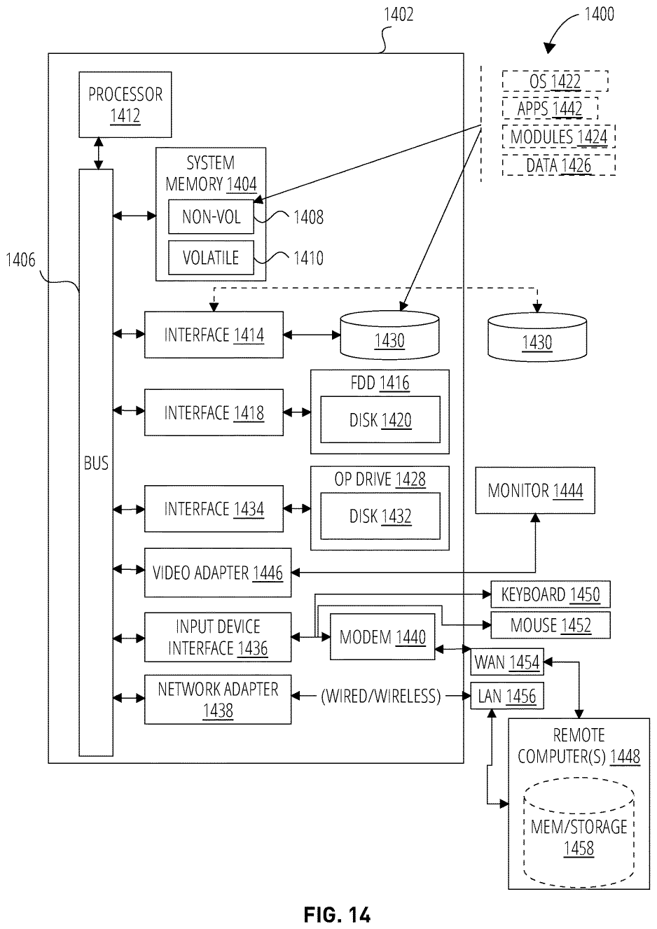

FIG. 14 illustrates an embodiment of an exemplary computer architecture 1400 suitable for implementing various embodiments as previously described. In one embodiment, the computer architecture 1400 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 1400. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media.

The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing computer architecture 1400 includes various common computing elements, such as one or more processors, multi-core processors, co-processors, processing circuit(s), memory units, chipsets, controllers, peripherals, interfaces, oscillators, timing devices, video cards, audio cards, multimedia input/output (I/O) components, power supplies, and so forth. The embodiments, however, are not limited to implementation by the computing computer architecture 1400.

As shown in FIG. 14, the computing computer architecture 1400 includes a processor 1412, a system memory 1404 and a system bus 1406. The processor 1412 can be any of various commercially available processors or processor circuits.

The system bus 1406 provides an interface for system components including, but not limited to, the system memory 1404 to the processor 1412. The system bus 1406 can be any of several types of bus structure that may further interconnect to a memory bus (with or without a memory controller), a peripheral bus, and a local bus using any of a variety of commercially available bus architectures. Interface adapters may connect to the system bus 608 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 1400 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1404 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 14, the system memory 1404 can include non-volatile 1408 and/or volatile 1410. A basic input/output system (BIOS) can be stored in the non-volatile 1408.

The computer 1402 may include various types of computer-readable storage media in the form of one or more lower speed memory units, including an internal (or external) hard disk drive 1430, a magnetic disk drive 1416 to read from or write to a removable magnetic disk 1420, and an optical disk drive 1428 to read from or write to a removable optical disk 1432 (e.g., a CD-ROM or DVD). The hard disk drive 1430, magnetic disk drive 1416 and optical disk drive 1428 can be connected to system bus 1406 the by an HDD interface 1414, and FDD interface 1418 and an optical disk drive interface 1434, respectively. The HDD interface 1414 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1408, and volatile 1410, including an operating system 1422, one or more applications 1442, other program modules 1424, and program data 1426. In one embodiment, the one or more applications 1442, other program modules 1424, and program data 1426 can include, for example, the various applications and/or components of the systems discussed herein.

A user can enter commands and information into the computer 1402 through one or more wire/wireless input devices, for example, a keyboard 1450 and a pointing device, such as a mouse 1452. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1412 through an input device interface 1436 that is coupled to the system bus 1406 but can be connected by other interfaces such as a parallel port, IEEE 1394 serial port, a game port, a USB port, an IR interface, and so forth.

A monitor 1444 or other type of display device is also connected to the system bus 1406 via an interface, such as a video adapter 1446. The monitor 1444 may be internal or external to the computer 1402. In addition to the monitor 1444, a computer typically includes other peripheral output devices, such as speakers, printers, and so forth.

The computer 1402 may operate in a networked environment using logical connections via wire and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all the elements described relative to the computer 1402, although, for purposes of brevity, only a memory and/or storage device 1458 is illustrated. The logical connections depicted include wire/wireless connectivity to a local area network 1456 and/or larger networks, for example, a wide area network 1454. Such LAN and WAN networking environments are commonplace in offices and companies, and facilitate enterprise-wide computer networks, such as intranets, all of which may connect to a global communications network, for example, the Internet.

When used in a local area network 1456 networking environment, the computer 1402 is connected to the local area network 1456 through a wire and/or wireless communication network interface or network adapter 1438. The network adapter 1438 can facilitate wire and/or wireless communications to the local area network 1456, which may also include a wireless access point disposed thereon for communicating with the wireless functionality of the network adapter 1438.

When used in a wide area network 1454 networking environment, the computer 1402 can include a modem 1440, or is connected to a communications server on the wide area network 1454 or has other means for establishing communications over the wide area network 1454, such as by way of the Internet. The modem 1440, which can be internal or external and a wire and/or wireless device, connects to the system bus 1406 via the input device interface 1436. In a networked environment, program modules depicted relative to the computer 1402, or portions thereof, can be stored in the remote memory and/or storage device 1458. It will be appreciated that the network connections shown are exemplary and other means of establishing a communications link between the computers can be used.

The computer 1402 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

Set forth below are various embodiments:

Embodiment 1: A method comprising: receiving, at a computing device, identification data associated with a user attempting to gain access to an online service system; in response to receiving the identification data, sending, by the computing device, a request to one or more issuer servers associated with contactless card issuers to determine if any of the contactless card issuers has a user account associated with the identification data, the request including the identification data; receiving, by the computing device, a reply from at least one of the one or more issuer servers associated with the contactless card issuers indicating that the identification data is associated with the user account and a contactless card associated with the at least one contactless card issuer; in response to receiving the reply, sending, by the computing device, a universal link to a mobile device associated with the user, wherein the user interacting with the universal link causes the mobile device to receive encrypted data from the contactless card; receiving, at the computing device, the encrypted data and forwarding the encrypted data to an authentication server to validate the encrypted data; and in response to the computing device receiving a message from the authentication server that the encrypted data has been validated, sending, by the computing device, a personal data element associated with the user to the online service system.

Embodiment 2: The method of embodiment 1, wherein the identification data associated with the user includes a name of the user and a phone number of the mobile device or an email address associated with the user.

Embodiment 3: The method of embodiments 1 to 2, wherein the online service system is a website with which the user is attempting to create a website account.

Embodiment 4: The method of embodiments 1 to 3, wherein the computing device is part of a switching and authentication network configured to route data from the contactless card and the online service system to the authentication server and the one or more issuer servers associated with the contactless card issuers.

Embodiment 5: The method of embodiments 1 to 4, wherein sending the universal link to the mobile device includes sending a short message service (SMS) message to the mobile device with a universal resource locator (URL) for the user to interact with, wherein the universal link comprises the URL.

Embodiment 6: The method of embodiments 1 to 5, wherein in response to the user interacting with the URL, the mobile device is caused to prompt the user to tap the contactless card to the mobile device to transmit the encrypted data from the contactless card to the mobile device, which then forwards the encrypted data to the computing device.

Embodiment 7: The method of embodiments 1 to 6, wherein the reply includes a list of contactless cards associated with the user account that are enabled to communicate with the computing device.

Embodiment 8: The method of embodiments 1 to 7, wherein the user is prompted with the list and instructed to select one of the contactless cards on the list.

Embodiment 9: The method of embodiments 1 to 8, wherein the authentication server is associated with the contactless card issuer of the contactless card selected by the user to be tapped to the mobile device.

Embodiment 10: The method of embodiments 1 to 9, further comprising: receiving, from a server associated with the contactless card issuer corresponding to the contactless card that the user tapped to the mobile device, the personal data element associated with the user, wherein the personal data element includes information related to the user's first and last name, birthdate, account address, primary account number, and expiry.

Embodiment 11: A non-transitory computer-readable storage medium having executable instructions stored thereon, which when executed by a processing circuit of a device, cause the processing circuit to: provide a website with identification data of a user to receive access to services of the website; receive, from a server in communication with the website, a universal link, wherein the user interacting with the universal link causes a prompt to be displayed for the user to tap a contactless card to the device; receive, from the contactless card, encrypted data to validate an identity of the user; send the encrypted data to an authentication frontend server, wherein the authentication front end server is to forward the encrypted data to an issuer authentication server associated with a contactless card issuer of the contactless card, the issuer authentication server to validate the identity of the user based on the encrypted data; and in response to the identity of the user being validated, obtain access to services of the website.

Embodiment 12: The non-transitory computer-readable storage medium of embodiment 11, wherein the identification data associated with the user includes a name of the user and a phone number of a mobile device or an email address associated with the user.

Embodiment 13: The non-transitory computer-readable storage medium of embodiments 11 to 12, wherein the user is attempting to create a user account with the website.

Embodiment 14: The non-transitory computer-readable storage medium of embodiments 11 to 13, wherein the universal link is received in one or more of: a short message service (SMS) message, a multimedia message server (MMS) message, an email, or social media message; and wherein the universal link includes a universal resource locator (URL) for the user to interact with.

Embodiment 15: The non-transitory computer-readable storage medium of embodiments 11 to 14, wherein in response to the user interacting with the URL, the processing circuit is caused to prompt the user to select the contactless card to tap to the device to transmit the encrypted data from the contactless card to the device.

Embodiment 16: The non-transitory computer-readable storage medium of embodiments 11 to 15, wherein the device is further caused to present a list of contactless cards associated with the user that are enabled to communicate with the device; and wherein the user is prompted to select one of the contactless cards on the list.

Embodiment 17: The non-transitory computer-readable storage medium of embodiments 11 to 16, wherein the website receives information from the authentication server including information related to the user's first and last name, birthdate, account address, primary account number, and expiry.

Embodiment 18: A server hosting a website or application, the server comprising: a memory storing executable instructions thereon; and a processing circuit to execute the executable instructions, which when executed cause the server to: receive identification data of a user attempting to obtain access to services of the website or application; send the identification data of the user to a computing device of a switching and authentication network, the computing device being in communication with one or more contactless card issuers to authenticate an identity of the user; in response to the identity of the user being authenticated, receive a personal data element associated with the user; generate a user account on the website or application using the personal data element; and grant access to services of the website or application to the user via the generated user account.

Embodiment 19: The server of embodiment 18, wherein the identification data associated with the user includes a name of the user and a phone number of the mobile device or an email address associated with the user.

Embodiment 20: The server of embodiments 18 to 19, wherein the personal data element associated with the user includes information related to the user's first and last name, birthdate, account address, primary account number, and expiry.

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

The various elements of the devices as previously described with reference to FIGS. 1-14 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method comprising:
receiving, at a computing device, identification data associated with a user attempting to gain access to an online service system;
in response to receiving the identification data, sending, by the computing device, a request to one or more issuer servers associated with contactless card issuers to determine if any of the contactless card issuers has a user account associated with the identification data, the request including the identification data;
receiving, by the computing device, a reply from at least one of the one or more issuer servers associated with the contactless card issuers indicating that the identification data is associated with the user account and a contactless card associated with the at least one contactless card issuer;
in response to receiving the reply, sending, by the computing device, a universal link to a mobile device associated with the user, wherein the user interacting with the universal link causes the mobile device to receive encrypted data from the contactless card;
receiving, at the computing device, the encrypted data and forwarding the encrypted data to an authentication server to validate the encrypted data; and
in response to the computing device receiving a message from the authentication server that the encrypted data has been validated, sending, by the computing device, a personal data element associated with the user to the online service system.

2. The method of claim 1, wherein the identification data associated with the user includes a name of the user and a phone number of the mobile device or an email address associated with the user.

3. The method of claim 1, wherein the online service system is a website with which the user is attempting to create a website account.

4. The method of claim 1, wherein the computing device is part of a switching and authentication network configured to route data from the contactless card and the online service system to the authentication server and the one or more issuer servers associated with the contactless card issuers.

5. The method of claim 1, wherein sending the universal link to the mobile device includes sending a short message service (SMS) message to the mobile device with a universal resource locator (URL) for the user to interact with, wherein the universal link comprises the URL.

6. The method of claim 5, wherein in response to the user interacting with the URL, the mobile device is caused to prompt the user to tap the contactless card to the mobile device to transmit the encrypted data from the contactless card to the mobile device, which then forwards the encrypted data to the computing device.

7. The method of claim 6, wherein the reply includes a list of contactless cards associated with the user account that are enabled to communicate with the computing device.

8. The method of claim 7, wherein the user is prompted with the list and instructed to select one of the contactless cards on the list.

9. The method of claim 8, wherein the authentication server is associated with the contactless card issuer of the contactless card selected by the user to be tapped to the mobile device.

10. The method of claim 1, further comprising:
receiving, from a server associated with the contactless card issuer corresponding to the contactless card that the user tapped to the mobile device, the personal data element associated with the user, wherein the personal data element includes information related to the user's first and last name, birthdate, account address, primary account number, and expiry.

11. A non-transitory computer-readable storage medium having executable instructions stored thereon, which when executed by a processing circuit of a device, cause the processing circuit to:
provide a website with identification data of a user to receive access to services of the website;
receive, from a server in communication with the website, a universal link, wherein the user interacting with the universal link causes a prompt to be displayed for the user to tap a contactless card to the device;
receive, from the contactless card, encrypted data to validate an identity of the user;
send the encrypted data to an authentication frontend server, wherein the authentication front end server is to forward the encrypted data to an issuer authentication server associated with a contactless card issuer of the contactless card, the issuer authentication server to validate the identity of the user based on the encrypted data; and
in response to the identity of the user being validated, obtain access to services of the website.

12. The non-transitory computer-readable storage medium of claim 11, wherein the identification data associated with the user includes a name of the user and a phone number of a mobile device or an email address associated with the user.

13. The non-transitory computer-readable storage medium of claim 11, wherein the user is attempting to create a user account with the website.

14. The non-transitory computer-readable storage medium of claim 11, wherein the universal link is received in one or more of: a short message service (SMS) message, a multimedia message server (MMS) message, an email, or social media message; and
wherein the universal link includes a universal resource locator (URL) for the user to interact with.

15. The non-transitory computer-readable storage medium of claim 14, wherein in response to the user interacting with the URL, the processing circuit is caused to prompt the user to select the contactless card to tap to the device to transmit the encrypted data from the contactless card to the device.

16. The non-transitory computer-readable storage medium of claim 15, wherein the device is further caused to present a list of contactless cards associated with the user that are enabled to communicate with the device; and
wherein the user is prompted to select one of the contactless cards on the list.

17. The non-transitory computer-readable storage medium of claim 11, wherein the website receives information from the authentication server including information related to the user's first and last name, birthdate, account address, primary account number, and expiry.

18. A server hosting a website or application, the server comprising:
a memory storing executable instructions thereon; and
a processing circuit to execute the executable instructions, which when executed cause the server to:
receive identification data of a user attempting to obtain access to services of the website or application;
send the identification data of the user to a computing device of a switching and authentication network, the computing device being in communication with one or more contactless card issuers to authenticate an identity of the user;
in response to the identity of the user being authenticated, receive a personal data element associated with the user;
generate a user account on the website or application using the personal data element; and
grant access to services of the website or application to the user via the generated user account.

19. The server of claim 18, wherein the identification data associated with the user includes a name of the user and a phone number of the mobile device or an email address associated with the user.

20. The server of claim 18, wherein the personal data element associated with the user includes information related to the user's first and last name, birthdate, account address, primary account number, and expiry.
